(19) United States
(12) Patent Application Publication
(10) Pub. No.: US 2005/0257625 A1
(43) Pub. Date: Nov. 24, 2005

(54) Angle of rotation sensor

(76) Inventor: Silvester Roessner, Aalen (DE)

Correspondence Address: JORDAN AND HAMBURG LLP, 122 EAST 42ND STREET, SUITE 4000, NEW YORK, NY, 10168, US

(21) Appl. No.: 11/048,566

(22) Filed: Jan. 31, 2005

(30) Foreign Application Priority Data
Feb. 28, 2004 (DE) 10 2004 009 839.5

(51) Int. Cl. G01L 3/02

(52) U.S. Cl. 73/862.327

(57) ABSTRACT

An angle of rotation sensor for determining a torque in a twistable shaft of a steering system has at least two magnetic scales, arranged concentrically about an axis of rotation, with a pole length of at least one of the scales, participating in the formation of the vernier, advantageously being modulated, so that a least possible number of regions of ambiguity result. Several rings are optionally disposed in such a manner, that the ambiguity regions of verniers formed do not mutually overlap.

### BACKGROUND

The invention relates to an angle of rotation sensor, especially for determining a torque in a twistable shaft of a steering system.

Various angle of rotation sensors for detecting an angle of rotation or angle of twisting of a shaft or of a torsion element and for determining a torque in a shaft are known.

DE 102 21 340 A1 describes a sensor arrangement for detecting the angle of rotation of a shaft, with a magnet element, generating a magnetic field, and a measuring element, detecting a magnetic field, the magnet element being constructed as a magnet ring, which has a magnetic field, which, in relation to the shaft, has an axial component and a tangential component. The angle of rotation of the shaft accordingly can be determined from the respective magnetization angle.

EP 1 092 956 A1 describes an electromagnetic angle of rotation sensor for detecting an angle of rotation at an axle, with a magnitude rotor, which can be rotated about the axle, and a stationary stator, which has means for detecting a magnetic field, directed onto the rotor, as well as at least four first and at least four second magnet detectors for detecting the magnetic field. The rotor and the stator are opposite to one another in such a manner, that an air gap, permeated by a magnetic field, is formed between them. The sensitivities of the first and second magnet detectors have values along a circle, which values can be enveloped by a sine curve, if the curve were to be unwound on a straight line. Permanent magnets and magnetic coils come into consideration as means for producing a periodic magnetic field. Hall sensors or induction coils are used as magnet detectors.

DE 101 10 785 C2 describes a steering angle sensor with a code disk, which is rotatably mounted and reproduces the angle of rotation of a steering wheel, with a scanning unit scanning the code of the code disk for determining the angular position of the steering wheel within a rotation, with a counting unit, mechanically coupled with the steering column or the code disk for counting a full revolution of the steering wheel relative to a zero position. The counting unit has sensors scanning the counting wheel and the angular position of the counting wheel. The transmission ratio of the code disk to the counting wheel is less than one and the counting wheel has different polarities. Two magnetic field sensors, disposed with a phase offset of 90° to one another, determine the angular position of the counting wheel.

DE 102 10 372 A1 describes an angle of rotation sensor, with a disk-shaped carrier of a first track of magnetic north and south poles and a second track of magnetic north and south poles with a number of north and south poles, differing from that of the first track, and with a sensor element each for detecting the first and second track. After the angle of rotation sensor is started up, a first, coarse determination of the angle of rotation of the track carrier is carried out with the first track and a high-resolution detection of the angle of rotation is brought about with the second track. The sinusoidal signal of the angle of rotation sensor is linearized with an angle function.

In DE 198 18 799 C2, an angle of rotation sensor with two magnetic rings and three assigned sensor elements is described. For determining an unambiguous angle within 360°, the known vernier method is used with a combination of Hall and MR sensors, the signals of the Hall sensor being used for range differentiation.

Furthermore, it is known from the state of the art that so-called magneto-resistive sensor elements are used in many angle sensors. Sensors of this type are used in saturation, in order to detect the angle of the incident magnetic field. AMR (anisotropic magneto-resistance) sensors are used particularly frequently here. However, sensor elements of this type cannot recognize the polarity of the magnetic field acting. A magnetic field angle α and an angle of α+π produce the same signal at the sensor. With that, AMR sensors always have an even number of signal periods and those implicitly contain the divider 2. If a vernier is constructed, for example, of an asymmetrical 22-pole and an asymmetrical 8-pole ring, the signals are repeated after 180°. This known state of affairs is shown in FIG. 1 for explaining the state of the art. It can be seen therein that an unambiguous determination of angle is not possible in any range. For example, it is not possible to differentiate period 1 from period 5 by means of the signals of the sensor. This is the case for all periods on the whole of the periphery

The known angle of rotation sensors are either complex or their resolution, accuracy and degree of reliability in critical applications, such as in automobile construction, are inadequate. Optical sensors have the disadvantage that they are very susceptible to contamination.

### SUMMARY

It is therefore an object of the invention to provide an angle of rotation sensor, the measurement accuracy and operational reliability of which are very high and with construction of which unambiguous determination of angles of 360° and higher becomes possible.

Briefly stated the present invention provides an angle of rotation sensor for determining a torque in a twistable shaft of a steering system which has at least two magnetic scales, arranged concentrically about an axis of rotation, with a pole length of at least one of the scales, participating in the formation of the vernier, advantageously being modulated, so that a least possible number of regions of ambiguity result. Several rings are optionally disposed in such a manner, that the ambiguity regions of verniers formed do not mutually overlap.

Accordingly, the present invention provides an angle sensor having at least two scales including first and second scales arranged concentrically about an axis of rotation, the first scale and the second scale pointing to consecutive magnetic north and south poles, the first and second scales having different numbers of pole pairs, a first number of pole pairs of the first scale and a second number of pole pairs of the second scale being relatively prime, at least one sensor element assigned to each of the first and second scales, at least one scale of the first and second scales having at least one pole that has a length which is different from that of remaining poles of said at least one scale, and at least two of the first and second scales in combination forming a partially ambiguous first vernier.

The present invention also provides a feature wherein the at least two scales includes at least a third scale forming a further ambiguous second vernier in combination therewith and the first and second verniers, in combination with one another, remove the ambiguities.

According to a feature of the invention, there is further provided the above angle of rotation sensor of wherein the first scale and the second scale form the first vernier and at least two of the assigned sensor elements are connected with an evaluating unit.

The present invention further includes the above angle of rotation sensor wherein the first and second scales are in a fixed operative connection with one another.

According to a still further feature of the invention, the above angle of rotation sensor has a twistable shaft element between the first scale and the second scale.

The present invention also includes the above embodiments wherein, in the alternative, various implementations of features of the above embodiments are incorporated. For example, the first vernier is formed from the first scale and the second scale and the second vernier is formed from the first scale and the third scale, the second scale and the third scale being arranged so that the ambiguous regions of the respective first and second verniers do not mutually overlap.

In another example the third scale has a sensor assigned thereto and the assigned sensor elements are connected with at least one evaluating unit.

Yet another example includes the above embodiments further comprising a twistable shaft element between the first scale and the second and third scales, the second scale being in fixed operative connection with the third scale.

Yet still another example of the present invention provides the above angle of rotation sensor wherein the at least two scales include a fourth scale and assigned sensor element and the first ambiguous vernier is formed from the first scale in combination with the second scale and the second ambiguous vernier is formed from the fourth scale in combination with the third scale, and ambiguity regions of the first and second verniers are not overlapping mutually. The sensor elements assigned to the first through fourth scales are connected with at least one evaluating unit.

In the above embodiment of the angle of rotation sensor, the first and second scales can be disposed on an input shaft and the third and fourth scales can be disposed on an output shaft in fixed operative connection with one another wherein there is no shaft element or a twistable shaft element between the input shaft and output shaft.

Yet another variant embodiment of the present invention includes a second evaluating unit connected with the first evaluating unit for transferring information in the above embodiment.

The present invention further includes a method employing any of the variant embodiments of angle sensors noted wherein a torque is calculated by means of a function, which contains at least two angles or a difference angle and a constant, which represents a stiffness of a twistable shaft, as input quantities.

### BRIEF DESCRIPTION OF THE DRAWINGS

FIG. 1 is an exploded, in part, perspective view of an embodiment of a portion of the invention illustrating assembly;

FIG. 2 is a side view of an asymmetric scale and a symmetric scale;

FIG. 3 is a graph illustrating modulation of an asymmetric 22-pole scale;

FIG. 4 is an exploded, in part, perspective view of another embodiment of a portion of the invention illustrating assembly;

FIG. 5 is a graph illustrating modulation of another asymmetric 22-pole scale;

FIG. 6 is an exploded, in part, perspective view of another embodiment of a portion of the invention illustrating assembly;

FIG. 7 is an exploded, in part, perspective view of still another embodiment of a portion of the invention illustrating assembly;

FIG. 8 is a schematic view of still another embodiment the invention;

FIG. 9 is a schematic view of yet another embodiment the invention; and

FIG. 10 is a schematic view of a still further embodiment the invention.

### DETAILED DESCRIPTION

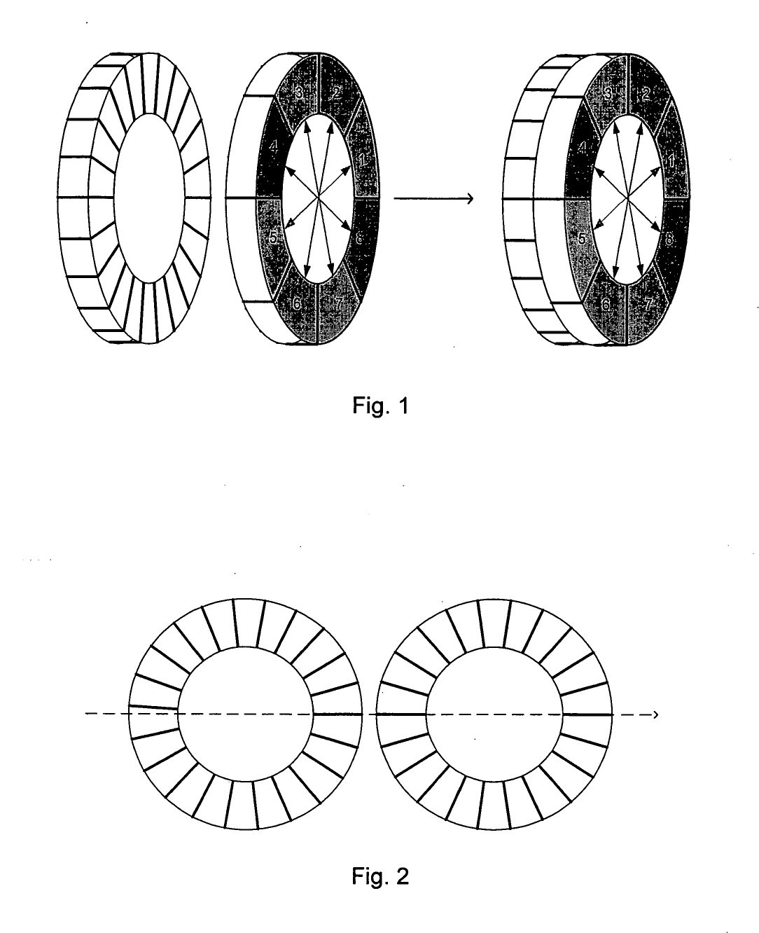

Referring to FIG. 1, the present invention includes two scales shown on the left of FIG. 1 that are magnetic and at least one of the magnetic scales, which participates in the formation of a vernier, shown on the right of FIG. 1, and may be disposed on a suitable backing, is configured asymmetrically. This is achieved by modulating pole lengths of one or more magnetic scales. In this connection, it is important that the vernier, that is, the arrangement of the two scales with respect to one another, be modulated.

In FIG. 2, the modulation for a 22-pole scale is shown by way of example of a symmetric 22-pole scale and an asymmetric 22-pole scale. The symmetry can be broken in various ways. In the example, a first 11 poles are shortened somewhat. To make up for the shortening, a next 11 poles are lengthened somewhat. A symmetry break can be recognized clearly by means of a broken line traversing the two illustrated scales. An The 8-pole scale retains its symmetrical construction. It is particularly advantageous to modulate further scales in a similar manner and, with that, to form further verniers.

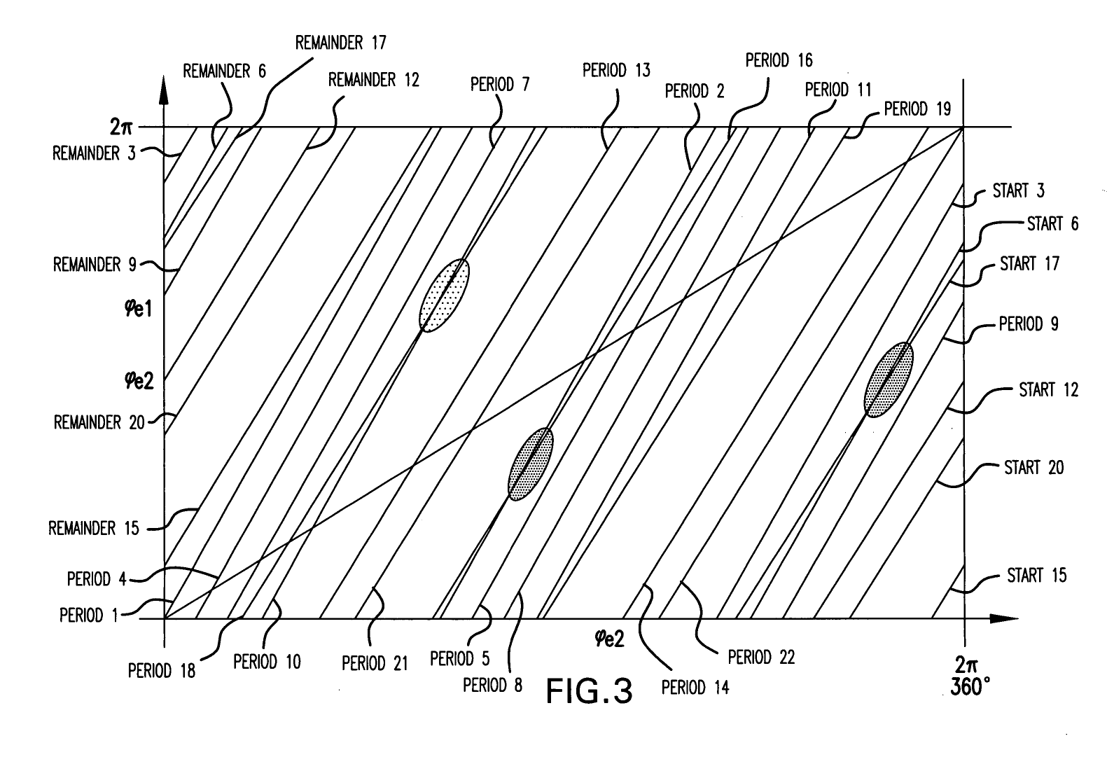

If a modulated scale forms a vernier system with an unmodulated scale, such as asymmetrical 8-pole scale, only a few regions result, in which the vernier formed is still ambiguous. The corresponding back-calculated angle values from the assigned sensor elements are shown in FIG. 3. The corresponding angle value φₑ₁ of the assigned 22-pole scale is plotted on the ordinate axis and the repeatedly swept angle values φₑ₂ of the eight-pole scale are plotted on the abscissa. An unambiguous determination of angle cannot be carried out at the intersections of the straight lines. It is not possible to differentiate between the following places.
Periods 1 and 6 of the 8-pole scale and 2 and 16 of the 22-pole scale
Periods 2 and 6 of the 8-pole scale and six and 17 of the 22-pole scale
Periods 4 and 7 of the 8-pole scale and 10 and 18 of the 22-pole scale.

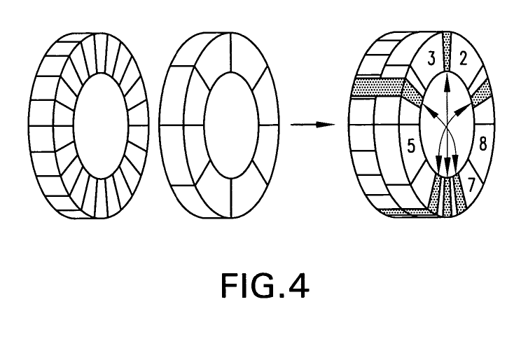

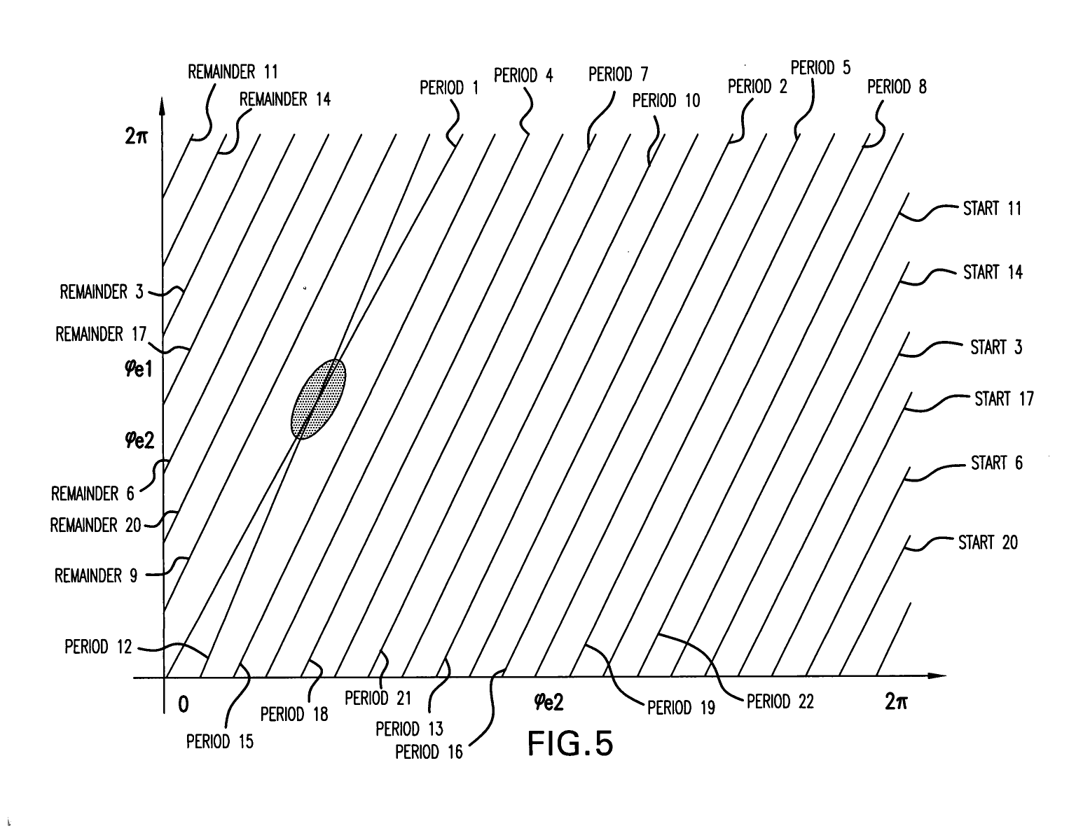

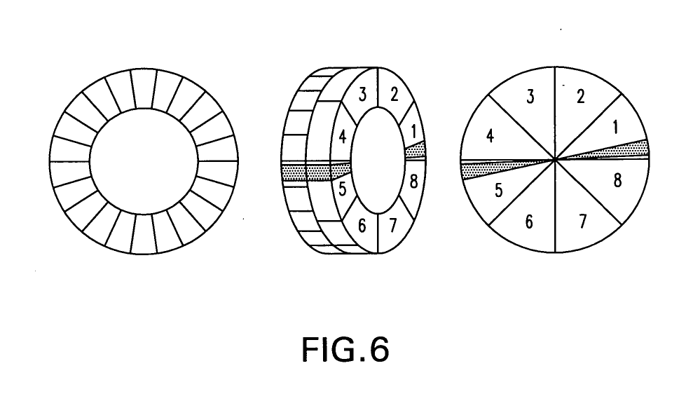

FIG. 4 shows the two scales forming a vernier. The regions of ambiguity are indicated by double arrows. It is regarded as particularly advantageous to limit the intersections of the straight lines of the resulting vernier system to the number one. The corresponding course of the angles is shown in FIG. 5. This constellation was achieved in that the pole at 0° was selected 12.5% larger and the pole at 180° 12.5% smaller than the remaining poles. FIG. 6 shows the two scales with the regions of ambiguity of the vernier resulting therefrom.

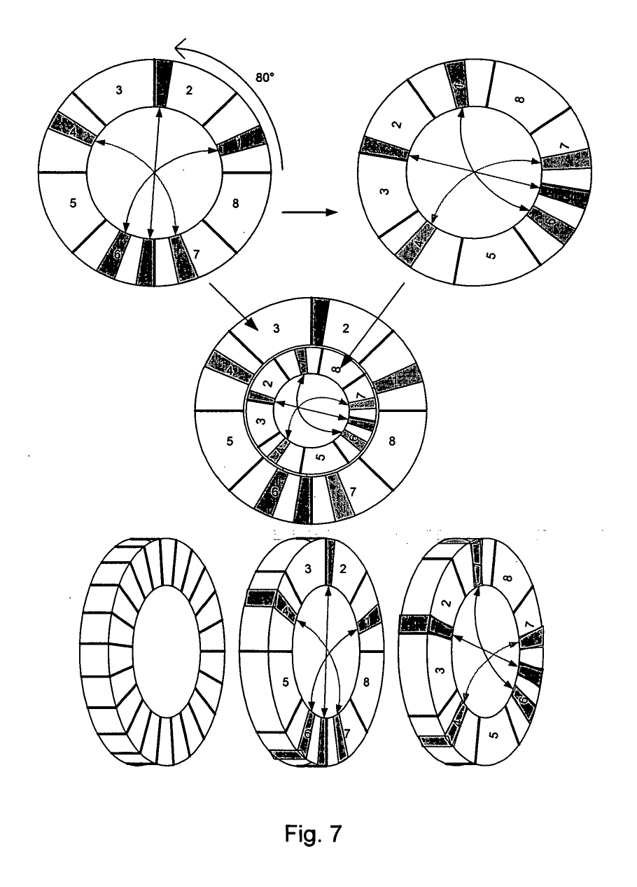

The arrangement, described in the following, is regarded as a particularly advantageous further development of the invention. By suitably combining at least two verniers affected by ambiguity regions, the certainty can be expanded once again to the full extent. As shown in the example in FIG. 7, an unmodulated 22-pole scale and two uniformly modulated, 8-pole scales are used to form to ambiguous verniers. One of the two modulated scales is disposed so that it is rotated by 80° with respect to the first modulated scale. Two verniers with their own ambiguity regions can be formed once again. At the same time, care must be taken to ensure that at least one of the two verniers is in its unambiguous region at each angular position of the arrangement. The corresponding evaluation can thereupon be carried out by means of signals of sensor elements assigned to the magnetic scales.

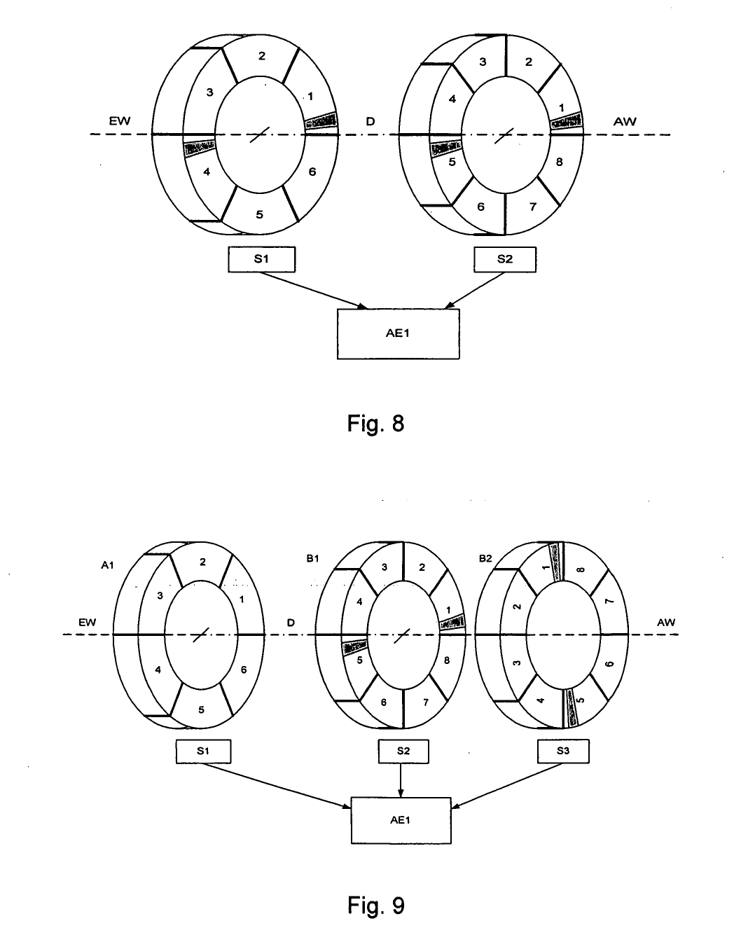

An angle sensor of FIG. 8, which has two scales, which together form a vernier, is proposed as a particularly simple embodiment. A sensor element s1, s2 is assigned to each of the scales. Each of the sensor elements, s1 and s2, is connected with an evaluating unit AE1. The scales can also be connected firmly with one another, perhaps on a common backing or on a shaft. Aside from the regions of ambiguity, an angle sensor of this construction is in a position, immediately it is switched on, to make available an unambiguous angle signal within a full revolution.

The regions of ambiguity may, moreover, also be reduced in size dynamically in that minimum movements of the sensor are utilized. By determining a slope of a straight line of the angle information, it is possible to recognize a angle range, in which the system happens to be. Typically, movements of the steering manipulation of the order of 0.1° would be sufficient for this, in order to carry out a difference measurement for identifying the slope. When a steering system is operated under practical conditions, the angle anyhow is tracked continuously. Regions of ambiguity then have no effect anymore and no longer are limiting. Alternatively, the sensor S1, S2 may be provided with a voltage, which is not interrupted, so that it never loses its position. In general, the vernier is necessary only for initialization after the switching on. After that, by appropriate signal processing by a counter in the evaluating unit AE1 or in a host system, an expansion of the unambiguous angle range to a multiple of 360° is even possible.

In a further advantageous version, a torque sensor is proposed, for which two scales are fixed on an input shaft EW and an output shaft AW. Between these, there is a torsion bar D or some other element, which can be twisted. The torque, acting on the torsion bar or element, is determined by means of an angle difference between the input shaft EW and the output shaft AW and a stiffness of the element, which can be twisted. If the angular offset of the shafts, AW and EW, is less than a specified limiting angle, the angle of rotation can be determined unambiguously for each of the two shafts, AW and EW, on 360° up to the regions of ambiguity. If the angle is tracked here also, the regions of ambiguity no longer have an effect.

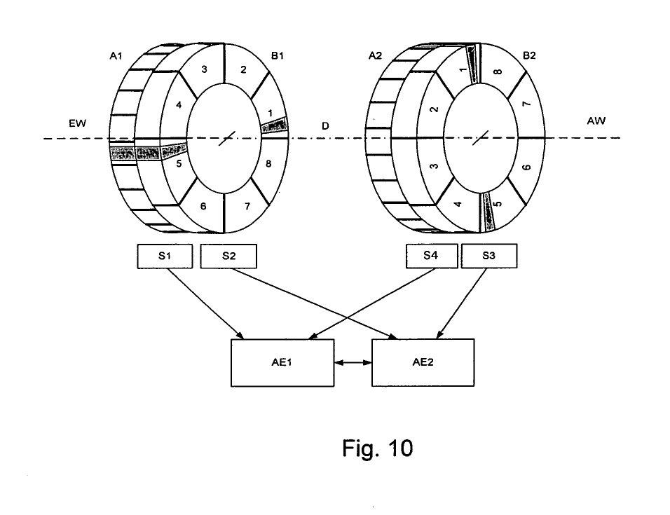

As a further, advantageous embodiment of FIG. 9, it is proposed that a torque sensor be constructed by fixing a third, offset scale B2 on the input shaft EW or the output shaft AW. The twistable shaft D is between the first scale A1 and the second and third scales B1, B2. Sensor elements S1, S2, S3, which are connected with an evaluating unit AE1, are assigned to the scales A1, B1 and B2. The regions of ambiguous vernier systems, formed from the first scale A1 in conjunction with the second scale B1 and from the first scale A1 in conjunction with the third scale B2, must not overlap. When switched on, it is immediately possible to determine the angle of the input and output shafts, EW and AW, unambiguously and, from this, to calculate the torque applied.

In a further, particularly advantageous version, a total of four scales A1, B1, A2, B2 and four assigned sensor elements S1, S2, S3, S4 are used. Each of the sensor elements is connected with an evaluating unit AE1 or AE2. The evaluating units are in a position to communicate with one another. In this embodiment, as shown in FIG. 10, two finely resolving and two coarsely resolving scales are used, pairs of which in turn form an ambiguous vernier. In this connection, two scales A1, B1 are fixed on an input shaft EW and two scales A2, B2 on an output shaft AW. Between the shafts, there is a twistable shaft D, such as a torsion rod of a power steering system. The sensor becomes redundant if the sensor elements S1, S2, S3, S4 are connected with the mutually communicating evaluating units AE1 and AE2. If a part sensor fails in operation, this is recognized by the host system and the steering system can be converted into a safe state.

1. An angle of rotation sensor, comprising:
at least two scales including first and second scales arranged concentrically about an axis of rotation,
the first scale and the second scale pointing to consecutive magnetic north and south poles,
the first and second scales having different numbers of pole pairs,
a first number of pole pairs of the first scale and a second number of pole pairs of the second scale being relatively prime,
at least one sensor element assigned to each of the first and second scales,
at least one scale of the first and second scales having at least one pole that has a length which is different from that of remaining poles of said at least one scale, and
at least two of the first and second scales in combination forming a partially ambiguous first vernier.

2. The angle of rotation sensor of claim 1, wherein the at least two scales includes at least a third scale forming a further ambiguous second vernier in combination therewith and the first and second verniers, in combination with one another, remove the ambiguities.

3. The angle of rotation sensor of claim 1, wherein the first scale and the second scale form the first vernier and at least two of the assigned sensor elements are connected with an evaluating unit.

4. The angle of rotation sensor of claim 3, wherein the first and second scales are in a fixed operative connection with one another.

5. The angle of rotation sensor of claim 3, further comprising a twistable shaft element between the first scale and the second scale.

6. The angle of rotation sensor of claim 2, wherein the first vernier is formed from the first scale and the second scale and the second vernier is formed from the first scale and the third scale, the second scale and the third scale being arranged so that the ambiguous regions of the respective first and second verniers do not mutually overlap.

7. The angle of rotation sensor of claim 6, the third scale has a sensor assigned thereto and the assigned sensor elements are connected with at least one evaluating unit.

8. The angle of rotation sensor of claim 6, further comprising a twistable shaft element between the first scale and the second and third scales, the second scale being in fixed operative connection with the third scale.

9. The angle of rotation sensor of claim 2, wherein the at least two scales include a fourth scale and assigned sensor element and the first ambiguous vernier is formed from the first scale in combination with the second scale and the second ambiguous vernier is formed from the fourth scale in combination with the third scale, and ambiguity regions of the first and second verniers are not overlapping mutually.

10. The angle of rotation sensor of claim 9, wherein of the sensor, elements assigned to the first through fourth scales are connected with at least one evaluating unit.

11. The angle of rotation sensor of claim 10, wherein the first and second scales are disposed on an input shaft and the third and fourth scales are disposed on an output shaft in fixed operative connection with one another and that there is no shaft element or a twistable shaft element between the input shaft and output shaft.

12. The angle of rotation sensor of claim 11, further comprising a second evaluating unit connected with the first evaluating unit for transferring information.

13. A method of providing measurement of torque comprising:
employing the angle of rotation sensor of claim 7 to measure first and second angles respectively of input and output shafts; and
calculating torque using a function, which accepts said first and second angles or a difference thereof, and a constant, which represents the stiffness of a twistable shaft, as input quantities.

14. A method of providing measurement of torque comprising:
employing the angle of rotation sensor of claim 10 to measure first and second angles respectively of input and output shafts; and
calculating torque using a function, which accepts said first and second angles or a difference thereof, and a constant, which represents the stiffness of a twistable shaft, as input quantities.

15. A method of providing measurement of torque comprising:
employing the angle of rotation sensor of claim 12 to measure first and second angles respectively of input and output shafts; and
calculating torque using a function, which accepts said first and second angles or a difference thereof, and a constant, which represents the stiffness of a twistable shaft, as input quantities.
